(19) United States
(12) Patent Application Publication
(10) Pub. No.: US 2003/0154122 A1
(43) Pub. Date: Aug. 14, 2003

(54) Consultancy scheduling, billing, and record keeping systems and methods

(76) Inventors: Chan Lawayne Jackson JR., Atlanta, GA (US); Sally C. Phillips, Snellville, GA (US)

Correspondence Address: Electronic Billing Systems, c/o CHAN JACKSON, 1445 MONROE DR NE # E33, ATLANTA, GA, 30324, US

(21) Appl. No.: 10/071,803

(22) Filed: Feb. 7, 2002

(51) Int. Cl. G06F 17/60

(52) U.S. Cl. 705/10

(57) ABSTRACT

Employers, referral agencies, consultants and independent contractors need each other. Employers outsource sign language interpreting, spoken language interpreting, court reporting, real time captioning and other support personnel services. Consultants and contractors provide information regarding their services and certification, degrees and experience through a subscription service allowing them access to a computerized scheduling, billing, and record keeping system. Referral placement agencies utilizing the environment post information concerning their respective services, fees, policies and the consultants or independent contractors available through such entities. Outsourcing companies search a database containing Agency's information to determine which entity meets a particular search criterion. Selected agencies receive job assignment information in a job request template. Agency representatives prepare a bid that is sent to the outsourcing companies for review. An outsourcing company will make their selection and award the job assignment to a particular agency or agencies for satisfying their particular job requirements. The environment's automated method provides Employers, Agencies, Consultants and Independent Contractors a method for identifying, planning, scheduling and managing personnel in an environment in which there are varying job requirements. Each employer, agency, consultant and contractor will have it's own work rules, schedule and operating constraints. Computerized scheduling, billing, record keeping and payment templates create an method and system for managing communications between a Consultant or Independent Contractor having particular qualifications and the Outsourcing Company seeking to hire Consultant(s) or Contractor(s). In a preferred embodiment, the environment created by the present invention includes an Agency Entity having a database for storing Consultant and Independent Contractor qualifications. A search program identifies the Consultant or Independent Contractor (s) qualified to respond to the Outsourcing Companies job request. A request is then submitted to the Consultant(s) or Contractor(s). A response is made either through the environment or through other traditional communication methods to the Agency's request. Using a wide range of security levels from passwords to cryptography the job request is considered filled. The Agency uses the environment to push the assigned Consultant(s) or Contractor(s) the specifics of the job request. The Agency then pushes the confirmation of assignment to the Outsourcing Company. Upon Completion of the assignment, the Consultant(s) or Contractor (s) will use the environment to bill and record their job related expenses. A ‘teaching tool’ in this embodiment use a better business practices for Consultants and Contractors by standardizing their record keeping. The environment and systems of the present invention have applications on the Internet.

### FEDERALLY SPONSORED RESEARCH & DEVELOPMENT

Not Applicable.

### REFERENCE TO SEQUENCE LISTING, A TABLE, OR A COMPUTER PROGRAM LISTING COMPAC DISK APPENDIX

Not Applicable.

### BACKGROUND OF INVENTION

The present invention relates to systems and methods for providing scheduling, billing, and record keeping for consultants, referral agencies and independent contractors. More particularly, the invention relates to systems and methods for outsourcing scheduling, billing, and record keeping functionality for consultants, referral agencies and independent contractors and unified scheduling, billing, and record keeping for such services to employers hiring independent contractors for specific job requests through a third party.

### DESCRIPTION OF RELATED ART

The Internet is a global network of connected computer networks. Over the last several years, the Internet has grown in significant measure. A large number of computers on the Internet provide information in various forms. Anyone with a computer connected to the Internet can potentially tap into this vast pool of information.

The most wide spread method of providing information over the Internet is via the World Wide Web (the Web). The Web consists of a subset of the computers connected to the Internet; the computers in this subset run Hypertext Transfer Protocol (HTTP) servers (Web servers). The information available via the Internet also encompasses information available via other types of information servers such as GOPHER and FTP.

Information on the Internet can be accessed through the use of a Uniform Resource Locator (URL). A URL uniquely specifies the location of a particular piece of information on the Internet. A URL will typically be composed of several components. The first component typically designates the protocol by which the address piece of information is accessed (e.g., HTTP, GOPHER, etc.). This first component is separated from the remainder of the URL by a colon (‘:’). The remainder of the URL will depend upon the protocol component. Typically, the remainder designates a computer on the Internet by name, or by IP number, as well as a more specific designation of the location of the resource on the designated computer. For instance, a typical URL for an HTTP resource might be: http:/www.server.com/dir1/dir2/resource.htm where http is the protocol, www.server.com is the designated computer and /dir1/dir2/resouce.htm designates the location of the resource on the designated computer.

Web servers host information in the form of Web pages; collectively the server and the information hosted are referred to as a Web site. A significant number of Web pages are encoded using the Hypertext Markup Language (HTML) although other encodings using the eXtensible Markup Language (XML) or the Standard Generic Markup Language (SGML) are becoming increasingly more common. The published specifications for these languages are incorporated by reference herein. Web pages in these formatting languages may include links to other Web pages on the same Web site or another. As will be known to those skilled in the art, web pages may be generated dynamically by a server by integrating a variety of elements into a formatted page prior to transmission to a Web client. Web servers and information servers of other types await requests for the information that they receive from Internet clients.

Client software has evolved that allows users of computers connected to the Internet to access this information. Advanced clients such as Netscape's Navigator and Microsoft's Internet Explorer allow users to access software provided via a variety of information servers in a unified client environment. Typically, such client software is referred to as browser software.

The networking of computers as a vehicle for distributing information and executing transactions provides a potential technology platform for implementing the consultancy billing systems and methods according to the present invention.

### SUMMARY OF THE INVENTION

The present invention is directed to systems and methods for outsourcing billing and record keeping functionality for agencies, consultants and independent contractors and unified billing and record keeping for such services to employers. In particular, a typical system according to the present invention includes a billing and record keeping environment that may include one or more servers that provide the billing and record keeping functionality. These or other servers may support access by agency, consulting and employing entities. Access to the environment may be via any suitable communication channel, which in a typical embodiment will be a computer network such as the Internet. The one or more servers may include or connect to a data store for storing information about consulting and employing entities utilizing the environment.

The employing entities may request services of consultants meeting selectable criteria including specific consultant education, pricing and certification criteria. An employing entity making a request may be matched with a consulting entity meeting the criteria selected in the request. In some embodiments, consolidating billing for various consulting entities participating in the environment may be prepared and presented to employing entities that used the services of the consulting entities. In some such embodiments, electronic payment of the consolidated billing may be accepted and distribution of such payments to the appropriate consulting entities may be accomplished. In some embodiments, various tax or accounting related statements (e.g. yearly 1099 statements) are prepared and distributed to consulting entities as appropriate.

Agency entities utilizing the environment may post relevant criteria concerning their respective services and the consultants available through such entities. Agency entities receive requests from employing entities either via the environment or through third party sources. Individual consultants, or other authorized users representing agency entities, may enter billing information concerning ongoing or completed consulting projects. The environment may generate bills to employing entities based upon the billing data entered. The bills may be prepared and forwarded to employing entities. Where the agency entity participates in the environment, the bill may be consolidated with billing from other participating consulting entities prior to forwarding to employing entities; such consolidated bills may be forwarded either via traditional channels such as mail or via electronic mechanism such as email or an interactive website (including, but not limited to various wireless mechanisms). In some embodiments, agency entities may also receive consolidated billing information with respect to work performed by particular consultants or for particular employing entities. Further, some embodiments may support periodic generation of accounting or tax related statements; in such embodiments, interfaces may be included to support input of data relevant to such statements that may be in addition to or instead of already entered billing data.

In some embodiments, agency entities may serve as intermediaries between consulting entities and employing entities. Consulting entities will typically act as independent contractors working for such agency entities. Employing entities may request jobs directly through the environment according to the present invention to registered agency entities in which case the agency entity will enter the job through the environment. In some embodiments, the environment will seek to connect the requester with consulting entities matching the criteria specified for the particular job. The environment may provide a variety of billing and record keeping functionality for agency entities/consulting entities.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 is a diagram of a typical system according to the present invention.

FIG. 2 is a diagram of a typical system embodiment including participation by agency entities.

FIG. 3 is a depiction of an interface for initially accessing functionality of the present invention.

FIG. 4 is a depiction of a set of sample-generated invoices as seen by a consulting entity.

FIG. 5 is a depiction of a sample-generated invoice as displayed to either an agency entity or an employing entity.

FIG. 6 is a depiction of a typical interface by which users may register with an environment according to the present invention.

FIG. 7 is a depiction of an interface by which an agency or employing entity might enter a job into the present invention.

### DETAILED DESCRIPTION OF THE INVENTION

A preferred embodiment of the invention is now described in detail. Referring to the drawings, like numbers indicate like parts throughout the views. As used in the description herein, the meaning of “a,” “an,” and “the” includes plural reference unless the context clearly dictates otherwise. Also, as used in the description herein, the meaning of “in” includes “in” and “on” unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

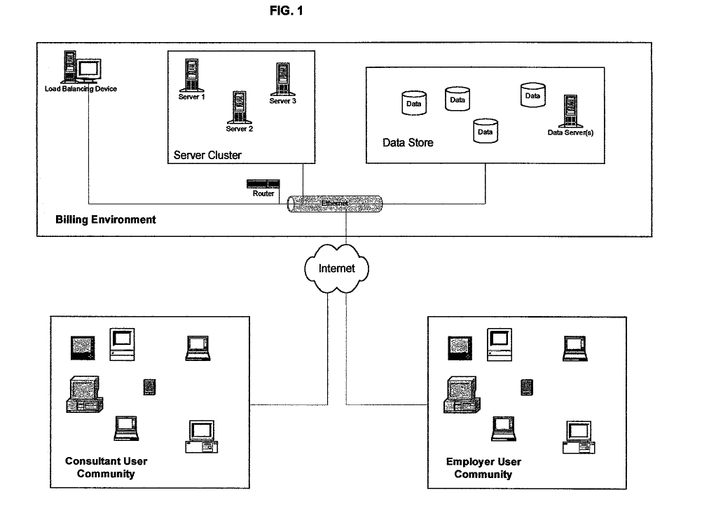

FIG. 1 depicts one architectural embodiment. A typical system according to the present invention includes a billing and record keeping environment that may include one or more servers that provide the billing and record keeping functionality. These or other servers may support access by consulting entities, agency entities, and employing entities. Access to the environment may be via any suitable communication channel, which in a typical embodiment will be a computer network such as the Internet. In some embodiments the access channel may provide security features; for instance, a secure socket layer (SSL) may be used with respect to an embodiment using the Internet as the access communication channel. The one or more servers may include or connect to a data store for storing information about consulting and employing entities utilizing the environment.

The various components of the environment may communicate with each other through any suitable communication architecture including, but not limited to, a computer network such as an Ethernet, token ring network or the Internet; a direct connection such as a bus connection, parallel or serial connection, null modem connection or wireless connection utilizing an appropriate communication protocol such as BLUETOOTH; and a dial-up connection. In embodiments where a single computer may provide all functional components, the communication may occur via bus connections, inter-process communication, shared files or some combination of these methods or other commonly utilized communication mechanisms.

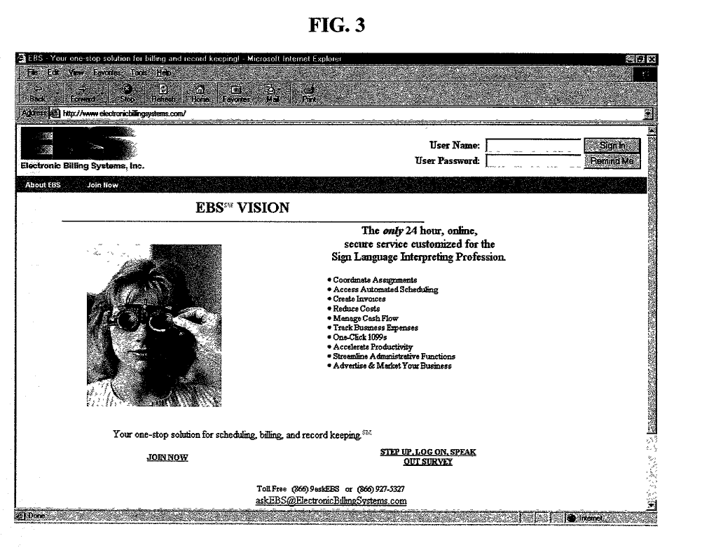

The architecture seen in FIG. 1 uses the Internet as a communication channel allowing access to the environment by consulting entities and employing entities. The environment uses a computer network such as the depicted Ethernet to allow communication among the components of the environment; a router is included in the environment to manage such communication within the internal network as well as managing the interface between the internal network and the Internet. The functionality of the environment is spread among a server cluster, a data store and, in some embodiments, a load balancing device. Where a load-balancing device is present, the device may be responsible for allocating and managing distribution of access among various elements within the server cluster and/or the data store. Consulting, agency and employing entities access the environment through standard Web browser software. FIG. 3 depicts a typical Web-based interface for entry to an environment according to the present invention.

The server cluster provides the billing, record keeping, and access functionality of the environment. In one embodiment, the server cluster may be divided into access servers and application servers where the access servers provide electronic access functionality such as by electronic mail server(s) and/or Web server(s) and the application servers provide the business functionality for supporting the billing and record keeping processes. In one embodiment, the one or more servers in the server cluster may be supported via 80×86 compatible hardware platforms preferably using at least a PENTIUM II class microprocessor (Intel Corp., Santa Clara, Calif.). The hardware platform would have an appropriate operating system such as WINDOWS 2000 (Microsoft, Redmond, Wash.), WINDOWS/NT (Microsoft, Redmond, Wash.), MAC/OS (Apple Computer Inc., Cupertino, Calif.) or LINUX (or other UNIX variant). Depending upon the hardware/operating system platform, appropriate server software may be included to support the desired application, email and Web server functionality. In one embodiment, the Web server functionality may be provided via an Internet Information Server (Microsoft, Redmond, Wash.). The email services may be supported via an Exchange Server (Microsoft, Redmond, Wash.). Application servers in some embodiments may be iPlanet Application Servers (iPlanet E-Commerce Solutions—A Sun | Netscape Alliance, Mountain View, Calif.). In one embodiment, the business application services may be provided through programmed pages on the Web server; such pages may use VBScript, Java Applet and/or Servelet technology to provide server side business logic and may use JavaScript to support client side business logic.

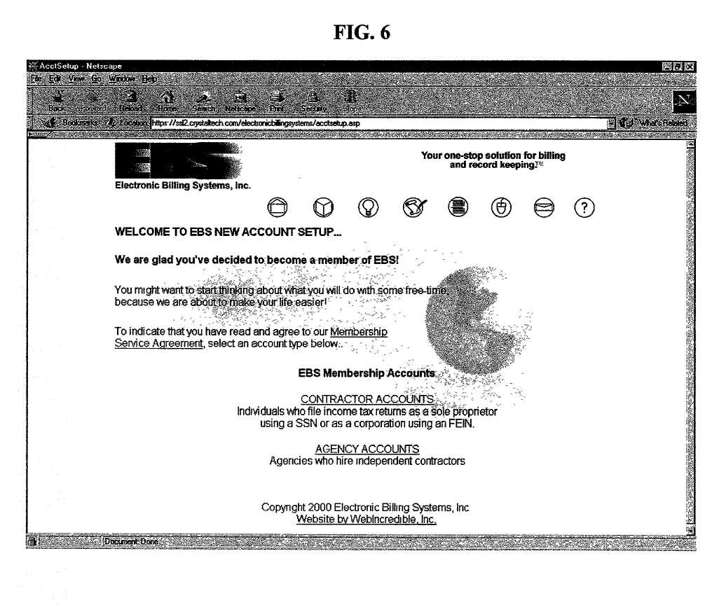

The data store provides for the storage and, potentially, the management of the data required by the environment. Information concerning consulting entities, agency entities and employing entities registered with the environment will be stored in the data store. FIG. 6 depicts one possible interface by which entities may register with a typical environment. Further, information will also be stored concerning the contracts and jobs the consulting entities may perform for the employing entities. The architecture of the data store may vary significantly in different embodiments. In one embodiment, relational database(s) are used to store and manipulate the data; in one such embodiment, one or more ORACLE 8I (Oracle Corp., Redwood Shores, Calif.) database management systems may be used in connection with a variety of storage devices/file servers. In other embodiments, the data store may use database systems with other architectures such as object-oriented, spatial, object-relational or hierarchical or may use other storage implementations such as hash tables or flat files.

In one embodiment, the environment is used for sign language interpretation consulting. Further details with respect to this embodiment are provided below. Those skilled in the art will understand that the principles outlined below will apply to other consultancy fields typically billed via hourly and daily billing rates or per job/project rates such as computer programming, accounting, plumbing, HVAC contractors, mediation, legal, temporary employees/agencies (e.g. clerical, accounting, management), general contractors, attorneys, spoken/foreign language interpretation, home health, lighting technicians, court reporters or other similar fields.

Consulting entities may register with the environment to receive outsource billing and record keeping support. The consulting entity provides information about itself including location, size, business identification number, etc. Agency entities that use multiple consultants may also provide administrative fee/rate mark-ups to be applied when a consultant working for an entity accepts a job through the agency entity. The mark-up may be applied to the consultant's hourly rate or to the overall job rate; further, the mark-up may be defined as a fixed increase or a percentage increase and may vary depending upon characteristics of a particular job or qualifications of particular consultant performing a job. For each consultant in the agency entity, billing rate, tax identification number and certification/experience information is entered. The certification/experience information may vary based upon the field of consulting. For instance in sign language interpretation, several national and state entities provide recognized certifications which may impact the billing rates for interpreters. The Registry of Interpreters for the Deaf, Inc. located in Silver Springs, Md. provides Comprehensive Skills Certificate (CSC), Certificate of Interpreting (CI), Certificate of Transliteration (CT), Combined CI/CT (CI/CT) and Certified Deaf Interpreter (CDI). Other national or state entities may have other certification/experience levels. Another example of certification/experience may be in the plumbing field where experience levels are defined in terms of apprentice, journeyman and master. In some embodiments, scheduling restrictions may also be entered per consultant. Depending upon the nature of the consulting entity and the field of consulting, additional information may be required.

For agency entities, location and business identification information should be entered. Also, rates may be entered for a particular employing entity. The rates in one embodiment may be fixed base rates that the employing entity will pay based upon certification/experience level of the hired consultant. Alternatively, the rates may be maximum base rates that the agency entity is willing to pay consultants with the required certification/experience level. The base rates may be further categorized by job type. For instance in sign language interpretation, differing base rates may be provided based upon the field of content being interpreted such as general interpretation, legal, technical, medical or mental health. In addition, hourly differentials may be applied based upon the circumstance of particular jobs such as emergency consulting, after hours consulting or highly technical consulting. In addition rates may be established for consultant travel time to and from a particular consulting job; these rates may be the same as for actual services or different. The agency entity may also indicate the types of expenses for which the consultant may be reimbursed such as travel (potentially including mileage, tolls, train/bus/air/cab fare, parking, etc.), lodging and meals.

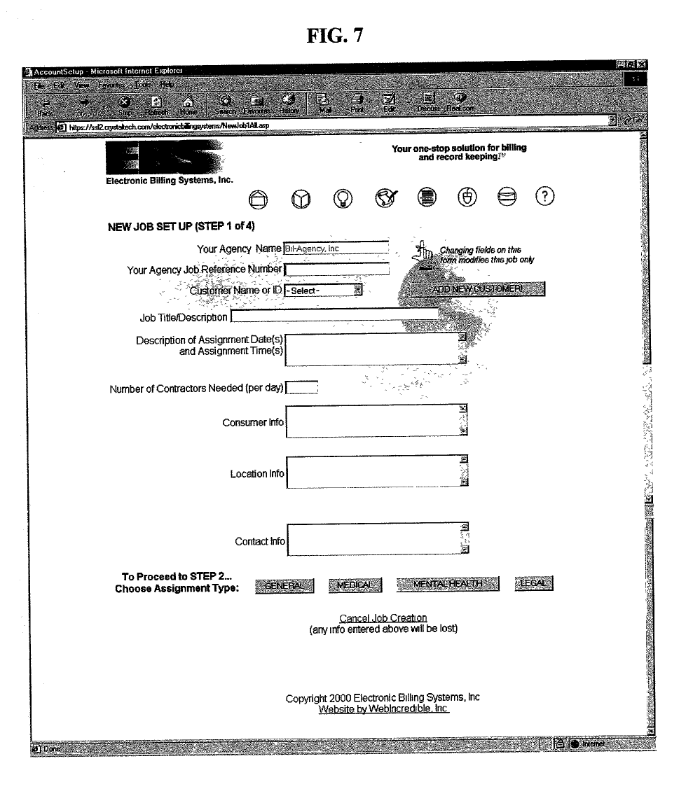

Agency entities may also enter requests for specific jobs; such a request would provide specific criteria such as consultant's history, education, certifications and/or licenses. FIG. 7 depicts the initial screen of an interface that might be used to enter information concerning a particular job; in this interface, industry specific assignment type information for the sign language interpretation is included in the row of buttons depicted with the legend “To Proceed to STEP 2 . . . ”. The environment will contact potential consultants meeting the employing entities criteria for the specific job. In addition, or instead, consulting entities may initiate a search for desired jobs for which the consulting entity may have qualified consultants. Once a match is found, a consultant can accept or reject a particular match. If rejected, additional matches may be requested. In one embodiment, all potential matched consultants are contacted, and the first to accept the particular job receives the contract.

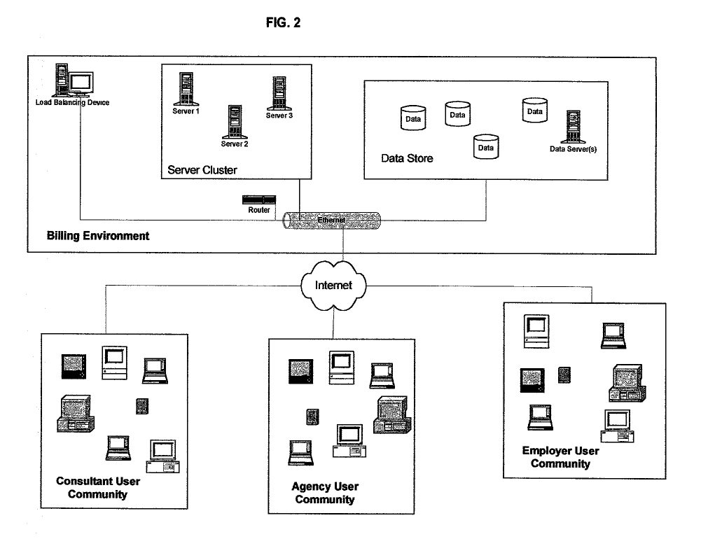

In some embodiments, agency entities may serve as intermediaries between consulting entities and employing entities. FIG. 2 depicts a block diagram of the architecture of a typical system including agency entities. Consulting entities will typically act as independent contractors working for such agency entities. Agency entities may in turn act as independent contractors to employing entities. The environment will typically perform the functionality for agency entities described above with respect to employing entities.

Employing entities may request jobs directly through the environment according to the present invention to registered agency entities in which case the agency entity may enter the job through the environment. Where agency entities enter the job, an analogous approach to the one described above with respect to employing entities may be used. In either situation, the environment will seek to connect the requester with consulting entities matching the criteria specified for the particular job.

The environment may provide a variety of billing and record keeping functionality for agency entities including, without limitation, invoicing of employing entities, automated receipt of invoices from consulting entities registered with the environment, record keeping interfaces for entering information related to work performed by consulting entities not registered with the environment and mark-up information for use in generation of invoices. Different embodiments may include differing mark-up schemes that may be based upon the type of job, the consulting entity performing the job, the employing entity requesting performance of the job or other suitable/industry specific criteria.

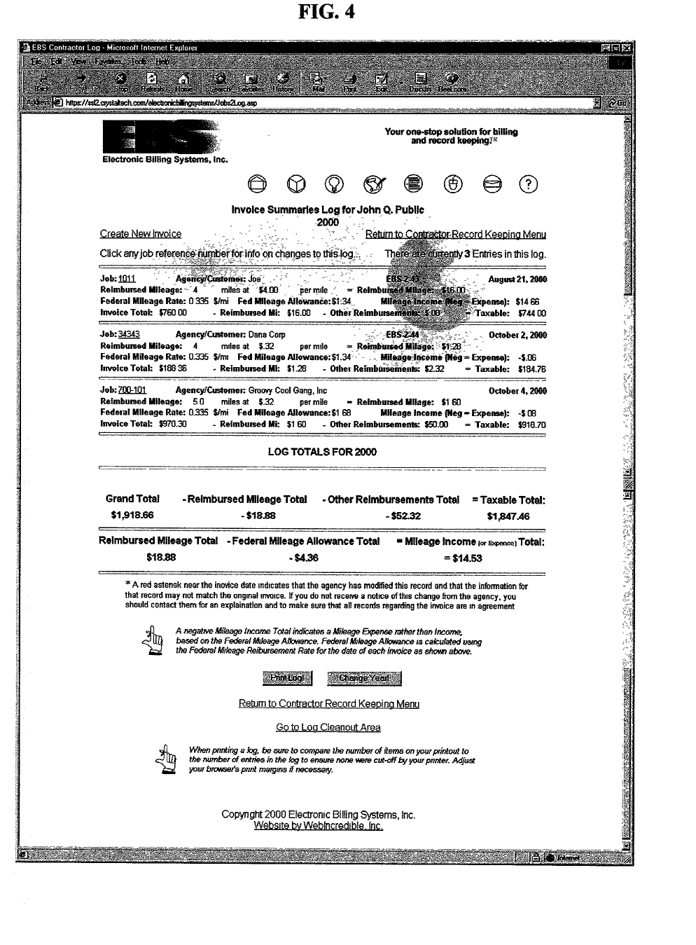

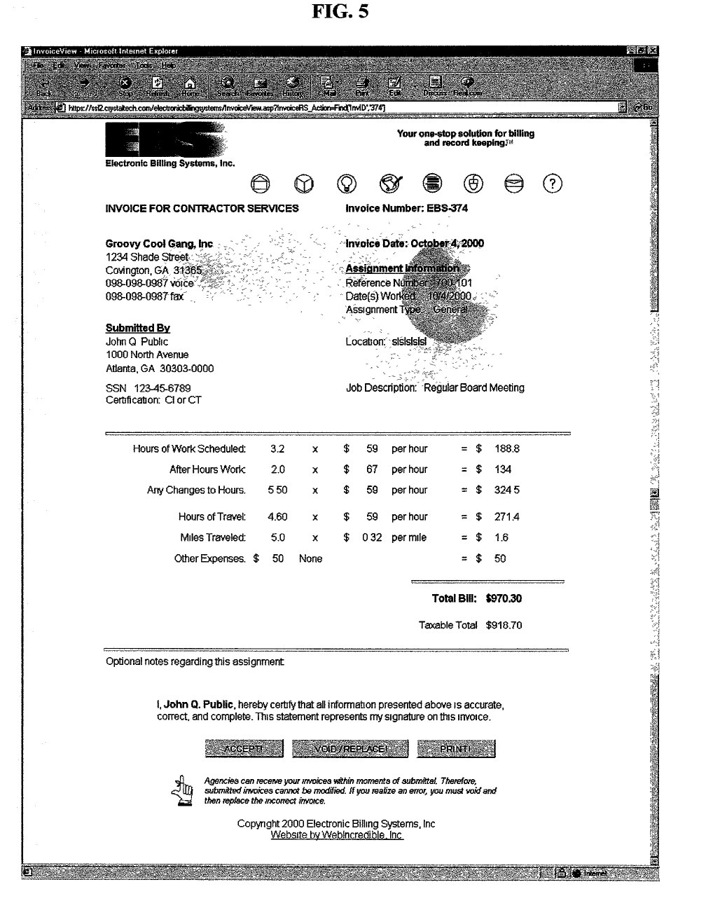

After completion of a particular job, a consultant may enter data related to the services performed and any required travel or expenses. The expenses that are entered are not limited to those reimbursable by the employing entity. The consultant will typically enter into the system any expenses related to the job that would either be reimbursable or an allowable business related deduction with respect to the consultant's taxes. FIG. 4 provides a sample screen that might be used to summarize pending invoices for a particular consulting entity, and through appropriate interface elements, allow tracking of current invoices and entry of new invoices. Copies of appropriate invoices for the job are automatically generated for both the consulting entity and the agency entity. FIG. 5 provides an example of the presentation of a typical invoice from a consulting entity to an employing entity or agency entity.

On a periodic basis (weekly, monthly, quarterly, etc) or upon demand, aggregated data may be provided to registered consulting entities and agency entities. For consulting entities, aggregated statement for consulting cash flow may be prepared. For agency and employing entities, aggregated invoices for consulting services may be prepared. In certain embodiments, employing entities may pay the aggregated, or in some embodiments individual job, invoices electronically via an appropriate mechanism such as electronic fund transfer, electronic bill pay services or credit card. Funds received from electronic payment are distributed based upon the presented invoices. Where less than the full amount is provided by the employing entity, certain disputed invoices may not be paid or payments may be split in a prorated fashion among consulting entities included in an aggregated invoice.

On a tax period basis, aggregated data may be prepared by the environment for both consulting and agency entities. For consulting entities, income from business and allowable expenses can be consolidated into a report suitable for tax preparation. In some embodiments, the environment may generate a downloadable or printable schedule C for an individual consultant as a consulting entity. On a tax period basis for agency entities, the environment may generate information as necessary for reporting or tax purposes. Further, appropriate tax forms such as 1099s may be generated for each consulting entity performing work for the particular agency entity. Finally, the agency entity may also receive consolidated expense information related to expenses reimbursed; such reports may be broken down by particular consulting entity and/or particular type of reimbursable expense.

Throughout this application, various publications may have been referenced. The disclosures of these publications in their entireties are hereby incorporated by reference into this application in order to more fully describe the state of the art to which this invention pertains.

The embodiments described above are given as illustrative examples only. It will be readily appreciated that many deviations may be made from the specific embodiments disclosed in this specification without departing from the invention.

What is claimed is:

1. A computerized, standardized environment for Employers, Agencies, Consultants and Independent Contractors providing a method for identifying, planning, scheduling and managing personnel in an environment in which there are varying job requirements.

2. In particular, a typical system according to the present invention includes a scheduling, billing, and record keeping environment that may include one or more servers that provide the scheduling, billing, and record keeping functionality. These or other servers may support access by agency, consulting and employing entities who choose to outsource sign language interpreting, spoken language interpreting, court reporting, real time captioning and other support personnel services. Access to the environment may be via any suitable communication channel, which in a typical embodiment will be a computer network such as the Internet. The typical embodiment automatically processes information associated with a plurality of different unaffiliated organizations;

3. Consultants and contractors provide information regarding their services and certification, degrees and experience through a subscription service allowing them access to a computerized scheduling, billing, and record keeping system. Referral placement agencies utilizing the environment post information concerning their respective services, fees, policies and the consultants or independent contractors available through such entities. Outsourcing companies search a database containing Agency's information to determine which entity meets a particular search criterion. Selected agencies receive job assignment information in a job request template. Agency representatives prepare a bid that is sent to the outsourcing companies for review. An outsourcing company will make their selection and award the job assignment to a particular agency or agencies for satisfying their particular job requirements. In some embodiments, agency entities may serve as intermediaries between consulting entities and employing entities. Consulting entities will typically act as independent contractors working for such agency entities. Employing entities may request jobs directly through the environment according to the present invention to registered agency entities in which case the agency entity will enter the job through the environment. In some embodiments, the environment will seek to connect the requestor with consulting entities matching the criteria specified for the particular job.

4. Consulting entities may register with the environment to receive outsource scheduling, billing, and record keeping support. The consulting entity provides information about itself including location, size, business identification number, etc.

5. Agency entities that use multiple consultants may also provide administrative fee/rate mark-ups to be applied when a consultant working for an entity accepts a job through the agency entity. The mark-up may be applied to the consultant's hourly rate or to the overall job rate; further, the mark-up may be defined as a fixed increase or a percentage increase and may vary depending upon characteristics of a particular job or qualifications of particular consultant performing a job. For each consultant in the agency entity, billing rate, tax identification number and certification/experience information is entered. The certification/experience information may vary based upon the field of consulting. In one embodiment, the invention recognizes in sign language interpretation, several national and state entities provide recognized certifications, which may impact the billing rates for interpreters. The Registry of Interpreters for the Deaf, Inc. located in Silver Springs, Md. provides Comprehensive Skills Certificate (CSC), Certificate of Interpreting (CI), Certificate of Transliteration (CT), Combined CI/CT (CI/CT) and Certified Deaf Interpreter (CDI). Other national or state entities may have other certification/experience levels. Another example of certification/experience may be in the plumbing field where experience levels are defined in terms of apprentice, journeyman and master.

6. In some embodiments, scheduling restrictions may also be entered per consultant. Depending upon the nature of the consulting entity and the field of consulting, additional information may be required.

7. For agency entities, location and business identification information should be entered.

8. Rates may be entered for a particular employing entity. The rates in one embodiment may be fixed base rates that the employing entity will pay based upon certification/experience level of the hired consultant. Alternatively, the rates may be maximum base rates that the agency entity is willing to pay consultants with the required certification/experience level. The base rates may be further categorized by job type. For instance in sign language interpretation, differing base rates may be provided based upon the field of content being interpreted such as general interpretation, legal, technical, medical or mental health. In addition, hourly differentials may be applied based upon the circumstance of particular jobs such as emergency consulting, after hours consulting or highly technical consulting. In addition rates may be established for consultant travel time to and from a particular consulting job; these rates may be the same as for actual services or different. The agency entity may also indicate the types of expenses for which the consultant may be reimbursed such as travel (potentially including mileage, tolls, train/bus/air/cab fare, parking, etc.), lodging and meals.

9. Agency entities may also enter requests for specific jobs; such a request would provide specific criteria such as consultant's history, education, certifications and/or licenses. The environment will contact potential consultants meeting the employing entities criteria for the specific job. Once a match is found, a consultant can accept or reject a particular match. If rejected, additional matches may be requested.

10. In one embodiment, all potential matched consultants are contacted, and the first to accept the particular job receives the contract.

11. Agency entities may in turn act as independent contractors to employing entities. The environment will typically perform the functionality for agency entities described above with respect to employing entities.

12. Employing entities may request jobs directly through the environment according to the present invention to registered agency entities.

13. After completion of a particular job, a consultant may enter data related to the services performed and any required travel or expenses. The expenses that are entered are not limited to those reimbursable by the employing entity.

14. Copies of appropriate invoices for the job are automatically generated for both the consulting entity and the agency entity.

15. In some embodiments, consolidating billing for various entities participating in the environment may be prepared and presented to employing entities that used the services of the agencies coordinating the consulting entities. In some such embodiments, electronic payment of the consolidated billing may be accepted and distribution of such payments to the appropriate consulting entities may be accomplished. The environment may generate bills to employing entities based upon the billing data entered. The bills may be prepared and forwarded to employing entities. Where the agency entity participates in the environment, the bill may be consolidated with billing from other participating consulting entities prior to forwarding to employing entities; such consolidated bills may be forwarded either via traditional channels such as mail or via electronic mechanism such as email or an interactive website (including, but not limited to various wireless mechanisms). In some embodiments, agency entities may also receive consolidated billing information with respect to work performed by particular consultants or for particular employing entities.

16. On a periodic basis or upon demand, aggregated data may be provided to registered consulting entities and agency entities,

17. For agency and employing entities, aggregated invoices for consulting services may be prepared.

18. In certain embodiments, employing entities may pay the aggregated, or in some embodiments individual job, invoices electronically via an appropriate mechanism such as electronic fund transfer, electronic bill pay services or credit card.

19. On a tax period basis, aggregated data may be prepared by the environment for both consulting and agency entities.

20. In some embodiments, various tax or accounting related statements (e.g. yearly 1099 statements) are prepared and distributed to consulting entities as appropriate. In such embodiments, interfaces may be included to support input of data relevant to such statements that may be in addition to or instead of already entered billing data.

21. The present invention presents an environment used for sign language interpretation consulting. Further details with respect to this embodiment are provided below. Those skilled in the art will understand that the principles outlined below will apply to other consultancy fields typically billed via hourly and daily billing rates or per job/project rates such as computer programming, accounting, plumbing, HVAC contractors, mediation, legal, temporary employees/agencies (e.g. clerical, accounting, management), general contractors, attorneys, spoken/foreign language interpretation, home health, lighting technicians, court reporters, real time Captioners and other support personnel.

22. The data store provides for the storage and, potentially, the management of the data required by the environment. Information concerning consulting entities, agency entities and employing entities registered with the environment will be stored in the data store. Further, information will also be stored concerning the contracts and jobs the consulting entities may perform for the employing entities. The architecture of the data store may vary significantly in different embodiments.

23. In one embodiment, relational database(s) are used to store and manipulate the data; in one such embodiment, one or more ORACLE 8I (Oracle Corp., Redwood Shores, Calif.) database management systems may be used in connection with a variety of storage devices/file servers.

24. In other embodiments, the data store may use database systems with other architectures such as object-oriented, spatial, object-relational or hierarchical or may use other storage implementations such as hash tables or flat files
a. Consulting entities, agency entities and employing entities registered with the environment will be stored in the data store.
